(19) United States
(12) Patent Application Publication
(10) Pub. No.: US 2023/0008377 A1
(43) Pub. Date: Jan. 12, 2023

(54) INFORMATION PROCESSING DEVICE, CONTROL METHOD, AND STORAGE MEDIUM

(71) Applicant: NEC Corporation, Minato-ku, Tokyo (JP)

(72) Inventors: Kan ARAI, Tokyo (JP); Daisuke TOKUSHIMA, Tokyo (JP); Yoshinori SAIDA, Tokyo (JP); Hiroto ONISHI, Tokyo (JP); Yousuke MOTOHASHI, Tokyo (JP)

(73) Assignee: NEC Corporation, Minato-ku, Tokyo (JP)

(21) Appl. No.: 17/778,904

(22) PCT Filed: Dec. 4, 2019
(86) PCT No.: PCT/JP2019/047498

§ 371 Date: May 23, 2022

(51) Int. Cl. G06Q 10/06; G06F 3/0484

(52) U.S. Cl. CPC G06Q 10/063112; G06F 3/0484

(57) ABSTRACT

An information processing device 1C mainly includes a segmentation unit 32C and a display control unit 33C. The segmentation unit 32C is configured to divide a similar job group, to which multiple workers engaged in a common or similar job belong, into multiple segments based on one or more attributes of the workers. The display control unit 33C is configured to display segment information, which is information regarding workers per segment, on the display device 4C.

### TECHNICAL FIELD

The present invention relates to a technical field of an information processing device, a control method, and a storage medium for controlling the display of information relating to a job.

### BACKGROUND ART

A method has been proposed to analyze documents related to a job thereby to determine the classification of the documents. For example, Patent Document 1 discloses a technique of performing keyword extraction from recruitment information and the like and determining similarities among plural pieces of recruitment information in units of topic.

### CITATION LIST

### Patent Literature

Patent Literature 1: WO2017/131043

### SUMMARY

### Problem to be Solved

In recent years, it has become important for each employee to make an autonomous career formation in line with changes in human resources required in accordance with the use of artificial intelligence and the like. In this case, it is necessary for each person to grasp their own value, enough or lacked skills, skills to be learned, and the like from an objective viewpoint. Similarly, it is necessary for managers and executives to understand the skills that subordinates and employees should learn in order to provide a guidance on career development for the subordinates and the employees. Patent Literature 1 does not disclose such a technique of displaying information for suitably supporting such carrier formation.

In view of the above-described issue, it is therefore an example object of the present disclosure to provide an information processing device, a control method and a storage medium capable of suitably presenting information for suitably supporting carrier formation.

### Means for Solving the Problem

In one mode of the information processing device, there is provided an information processing device including: a segmentation unit configured to divide a similar job group, to which multiple workers engaged in a common or similar job belong, into multiple segments based on one or more attributes of the workers; and a display control unit configured to display segment information, which is information regarding workers per segment, on a display device.

In one mode of the control method, there is provided a control method executed by an information processing device, the control method including: dividing a similar job group, to which multiple workers engaged in a common or similar job belong, into multiple segments based on one or more attributes of the workers; and displaying segment information, which is information regarding workers per segment, on a display device.

In one mode of the storage medium, there is provided a storage medium storing a program executed by a computer, the program causing the computer to function as: a segmentation unit configured to divide a similar job group, to which multiple workers engaged in a common or similar job belong, into multiple segments based on one or more attributes of the workers; and a display control unit configured to display segment information, which is information regarding workers per segment, on a display device.

### Effect

An example advantage according to the present invention is to present information for suitably supporting carrier formation.

### BRIEF DESCRIPTION OF THE DRAWINGS

FIG. 1 illustrates the configuration of a skill management system according to a first example embodiment.

FIG. 2 illustrates an example of the data structure of the job related database (DB: DataBase).

FIG. 3A illustrates the block configuration of an information processing device.

FIG. 3B illustrates the block configuration of a display device.

FIG. 4 illustrates an example of a functional block of a processor of the information processing device.

FIG. 5A illustrates a part of the text that indicates a job goal of a worker.

FIG. 5B illustrates a part of the text that indicates a comment by the superior to the worker.

FIG. 5C illustrates a part of the text that indicates the job history of the worker.

FIG. 6 is an example of a flowchart showing a procedure relating to the display process in the first example embodiment.

FIG. 7 is a display example of a segment distribution view which displays the distribution of the number of persons for each segment.

FIG. 8 is an example of the display of the segment distribution view after “all data including other companies” is selected in the target worker selection field and “position” is selected in the second attribute selection field.

FIG. 9 is a display example of the skill statistics view related to the statistical display of the skills.

FIG. 10 is a display example of the skill statistics view when “job related words” is selected in the display type selection field.

FIG. 11 is a display example of the skill statistics view indicative of statistical information on the difference in skills when two segments are selected.

FIG. 12 is a display example of the skill statistics view indicative of the result of integration of statistical information on the skills when multiple segments are selected.

FIG. 13 illustrates a schematic configuration of a skill management system in a second example embodiment.

FIG. 14 illustrates a functional block diagram of an information processing device according to a third example embodiment.

FIG. 15 is an example of a flowchart showing a procedure relating to the display process executed by the information processing device in the third example embodiment.

FIG. 16 is a schematic configuration diagram of an information processing device in a fourth example embodiment.

### EXAMPLE EMBODIMENTS

Hereinafter, an example embodiment of an information processing device, a control method, and a storage medium will be described with reference to the drawings.

### First Example Embodiment

(1) System Configuration

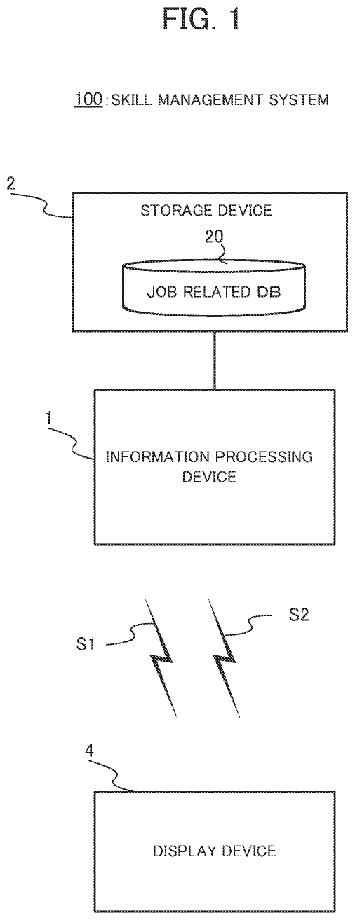

FIG. 1 shows the configuration of the skill management system 100 according to the first example embodiment. The skill management system 100 is a system for managing and presenting information on the skills of workers engaged in jobs. The skill management system 100 mainly includes an information processing device 1, a storage device 2, and a display device 4. The term “worker” herein includes an employee of an company, an employee belonging to a national or local government, and any other worker.

The information processing device 1 generates, by referring to the information stored in the storage device 2, a display signal “S2” corresponding to the input signal “S1” received from the display device 4, and transmits the display signal S2 to the display device 4. As will be described later, the information processing device 1 refers to the job related DB 20 stored in the storage device 2 and divides (classifies) the workers into a plurality of groups (also referred to as “similar job groups”) each including members having common or similar jobs, and further divides workers of a particular similar job group into a plurality of segments based on attributes such as annual income. Then, the information processing device 1 generates a display signal S2 for displaying information (segment information) relating to the workers per segment. This segment information includes information on the number of workers per segment and statistical information on skills of workers per segment, as will be described later.

The storage device 2 stores the job related DB 20 which is a database of information (also called “job related information”) regarding the job of each of the workers. The job related DB 20 may include the job related information regarding workers belonging to each division in one company, or the job related information regarding workers of multiple companies. In addition, the job related DB 20 may include information managed by a personnel-recruiting company or the like as the job related information. The job related DB 20 in this case includes job related information regarding the human resources that the personnel-recruiting company can offer. The structure of the job related DB 20 will be described below.

The storage device 2 may be an external storage device such as a hard disk connected to or built in to the information processing device 1, or may be a storage medium such as a flash memory that is detachable from the information processing device 1. The storage device 2 may include one or more server devices that perform data communication with the information processing device 1. The database or the like stored in the storage device 2 may be distributed and stored by a plurality of devices or storage media.

The display device 4 is a terminal used by a viewer, for example, and transmits an input signal S1 based on the input by the viewer to the information processing device 1 and in response receives the display signal S2 from the information processing device 1 and displays information based on the display signal S2. Examples of the viewer may include a worker voluntary seeking an career and a manager or executive with the workers as subordinates or employee. As will be described later, the display device 4 displays, based on the display signal S2, a view (also referred to as a “segment distribution view”) showing the distribution of the workers for each segment, and a view (also referred to as a “skill statistics view”) showing statistical information on the skills of the workers per segment, respectively.

The information processing device 1 may be configured by a plurality of devices. In this case, a plurality of devices constituting the information processing device 1 exchange information necessary for executing the pre-allocated processing among the plurality of devices.

(2) Data Structure

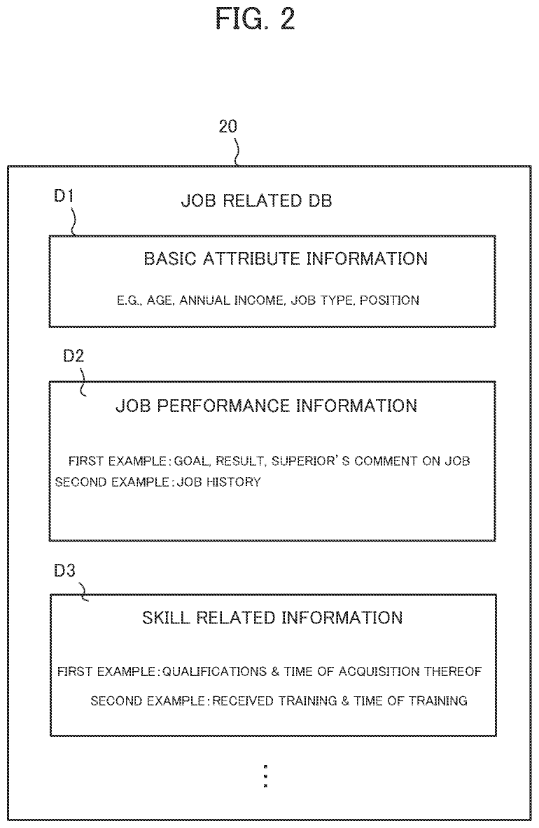

FIG. 2 illustrates an example of the data structure of the job related DB 20. The job related DB 20 mainly includes the basic attribute information D1, the job performance information D2, and the skill related information D3 for each worker.

The basic attribute information D1 is information indicative of basic attributes related to jobs of the workers. The basic attribute information D1 includes, for example, information indicative of the age, the annual income, the job type, and the position (post) of each worker. The basic attribute information D1 is referred to, for example, when dividing workers into a plurality of segments in units of workers with common or similar jobs. It is noted that the information indicative of the annual income, the age, and the like need not be the information at the present time and it may be the information at the time of collecting the job related information. For example, if the job related information based on the resume data of job seekers collected by a recruitment agency is included in the job related DB 20, the basic attribute information D1 includes the information indicative of the annual income, age, and the like of the job seekers at the time when the recruitment agency collects the resume data.

The job performance information D2 is information indicative of the job performance of each of the workers. The first example of job performance information D2 is information indicative of the job performance of the worker collected by the company every half year (or year). In this case, the job performance information D2 is, for example, text information describing the job goals and results of each worker, and text information indicative of a comment to the worker by the superior of the worker. The second example of the job performance information D2 is information indicative of the job history. This information may be text information (e.g., text information extracted from the resume) regarding the job history of a person who wishes to change jobs collected by a recruitment agency or the like, or it may be text information regarding the job history of a person who has changed jobs collected at the time of adoption by the company that accepted the person.

The skill related information D3 is information regarding the skill of the worker. The first example of the skill related information D3 is information regarding qualifications possessed by each of the workers. Specifically, examples of the information include identification information indicative of the qualifications possessed by the worker and information indicative of the time of acquiring each of the qualifications (e.g., length of service at the time of acquiring each of the qualifications). The second example of skill related information D3 is information regarding trainings received by each of the workers. Specifically, examples of the information include the identification information indicative of the trainings received by the worker and information indicative of the time of receiving each of the trainings (e.g., length of service at the time of receiving each of the trainings). The skill related information D3 may be information managed by the company based on declarations from each workers, or it may be information extracted from the resumes of career-changers collected by a recruitment agency.

The basic attribute information D1, the job performance information D2, and the skill related information D3, which are recorded in the job related DB 20, are associated with the identification information (also referred to as the “personal ID”) indicative of the corresponding workers and information indicative of the affiliation (belonging) of the workers. The personal ID may be an ID assigned by an organization (company) to which the worker belongs, or it may be an ID allocated by a public organization, or it may be identification information utilized in biometric certification such as face certification, iris certification, an fingerprint certification.

The job related DB 20 may be configured by a plurality of databases. In this case, the job related DB 20 may be managed in a distributed manner by a plurality of storage devices 2.

(3) Block Configuration

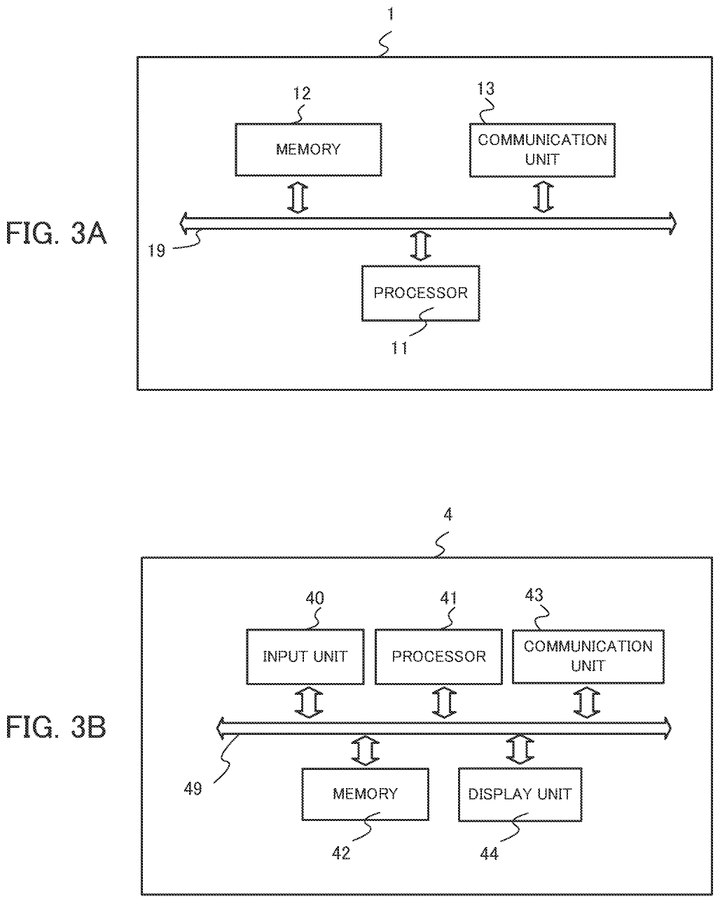

FIG. 3A shows an example of a block configuration of the information processing device 1. The information processing device 1 includes, as hardware, a processor 11, a memory 12, and a communication unit 13. The processor 11, the memory 12, and the communication unit 13 are connected to one another via a data bus 19.

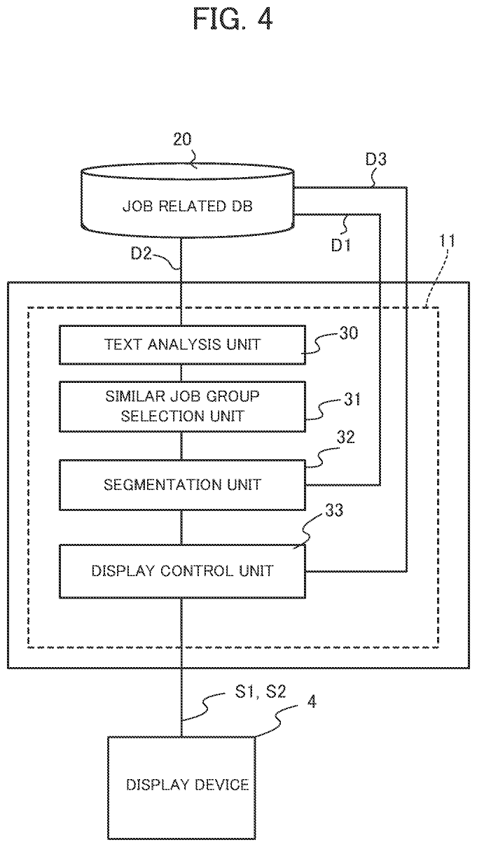

The processor 11 executes a predetermined process by executing a program stored in the memory 12. The processor 11 is one or more processors such as a CPU (Central Processing Unit) and a GPU (Graphics Processing Unit). The process executed by the processor 11 will be described in detail with reference to the functional block diagram shown in FIG. 4.

The memory 12 is configured by various memories such as a RAM (Random Access Memory), a ROM (Read Only Memory), and other nonvolatile memories. In addition, a program for executing a predetermined process by the information processing device 1 is stored in the memory 12. The memory 12 is used as a work memory and temporarily stores information acquired from the storage device 2. The memory 12 may function as the storage device 2. Similarly, the storage device 2 may function as the memory 12 of the information processing device 1. The program executed by the information processing device 1 may be stored in a storage medium other than the memory 12.

The communication unit 13 is an interface that is connected to a communication module or the communication module for performing data communication with each of external devices such as the storage device 2 and the display device 4 and the information processing device 1.

The configuration of the information processing device 1 is not limited to the configuration shown in FIG. 3A. For example, the information processing device 1 may be connected to or incorporate at least one of a an input unit for receiving an input by a user, a display unit such as a display, or a sound output device such as a speaker. For example, the information processing device 1 may be a tablet type terminal or the like in which the input function and the output function are integrated with the main body.

FIG. 3B shows an example of a block configuration of the display device 4. The display device 4 includes, as hardware, an input unit 40, a processor 41, a memory 42, a communication unit 43, and a display unit 44. Each element of these display devices 4 is connected to each other via a data bus 49.

The input unit 40 receives an input or the like by the viewer for specifying information to be displayed on the display device 4. Examples of the input unit 40 include a button, a switch, a touch panel, a voice input device, and an interface for connecting thereto. The processor 41 executes a predetermined process by executing a program stored in the memory 42. The processor 41 is one or more processors such as a CPU, GPU, and the like. The memory 42 is configured by various memories such as a RAM, a ROM, and other non-volatile memories.

Further, the memory 42 stores a program for the display device 4 to execute a predetermined process. The memory 42 is also used as a working memory.

The communication unit 43 is a communication module or an interface for connecting the communication module for the display device 4 to communicate with other devices such as the information processing device 1. The display unit 44 is a display, a projector, or an interface for connecting thereto.

(4) Functional Block

FIG. 4 is an example of a functional block of the processor 11 of the information processing device 1. The processor 11 of the information processing device 1 functionally includes a text analysis unit 30, a similar job group selection unit 31, a segmentation unit 32, and a display control unit 33.

The text analysis unit 30 acquires the job performance information D2 from the job related DB 20 through the communication unit 13 or the like and analyzes the text information included in the job performance information D2.

In this case, using any morphological analyzer such as MeCab, the text analysis unit 30 firstly extracts words (also referred to as “job related words”) related to the job of the worker of interest from texts indicated by the job performance information D2 extracted from the job related DB 20. The job related word extracted in this case may be a word (e.g., a noun) after removal of specific parts such as a particle and an article, or may be a word that matches the keyword relating to the job registered in advance. In another example, the job related word may be a composite word (synthetic word or vocabulary) that is obtained by combining a plurality of words.

Next, the text analysis unit 30 converts the extracted job related words into feature vectors with N (N is an integer) dimensions. For example, the text analysis unit 30 performs conversion from the job related words to the feature vectors by using a learning model such as a neural network, wherein the learning model is learned using training data which includes job related words and texts from which the job related words are extracted. Examples of an algorithm for converting the job related words into feature vectors include Word2Vec.

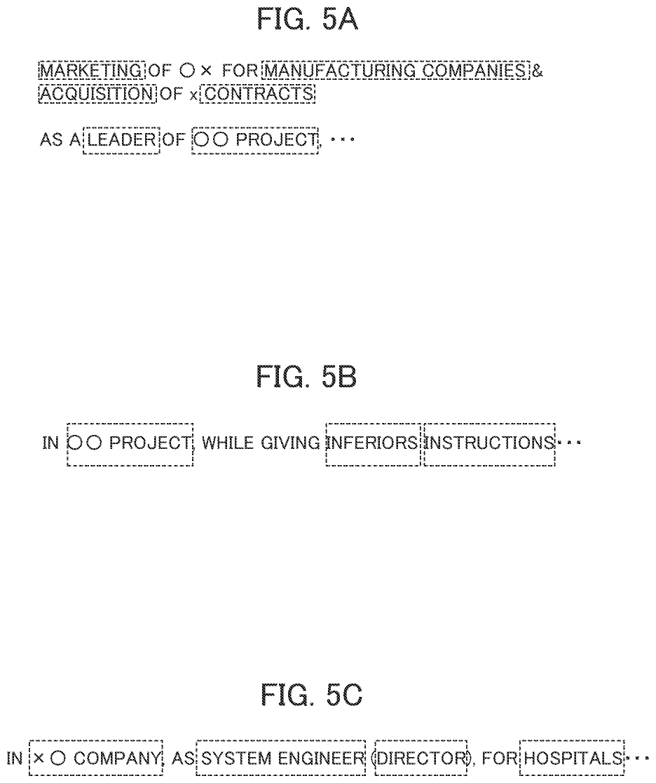

Here, a specific example of the extraction processing of the job related words from the texts indicated by the job performance information D2 by the text analysis unit 30 will be described. FIGS. 5A to 5C illustrate exemplary texts indicated by the job performance data D2 extracted from the job related DB 20. In FIGS. 5A to 5C, each broken line frame indicates an example of a job related word that is extracted by the text analysis unit 30. Here, FIG. 5A shows a part of the text that indicates the job goal of the worker, which was described as the first example of the job performance information D2, and FIG. 5B shows a part of the text that indicates the comment by the superior to the worker. FIG. 5C shows a part of the text that indicates the job history of the worker, which was described as the second example of the job performance information D2.

As shown in FIGS. 5A to 5C, the job performance information D2 includes a number of words related to the job of the target worker. Therefore, the text analysis unit 30 can acquire the job related words that suitably reflects the job of each worker by analyzing the texts indicated by the job performance information D2 corresponding to each worker.

By referring again to FIG. 4, a description will be given of each functional block of the information processing device 1.

The similar job group selection unit 31 groups (i.e., generates similar job groups) workers engaged in similar jobs (including the common job) based on the feature vectors of multiple job related words extracted from the job performance information D2 corresponding to each worker. In this case, the similar job group selection unit 31 first calculates the mean vector (vector of center of gravity) of the feature vectors of the job related words for each worker, and uses the calculated mean vector as a feature vector (also referred to as “worker vector”) representing the job of the worker of interest. Here, since the worker vector is calculated from the feature vectors of the job related words extracted by the text analysis unit 30, the closer jobs of workers are, the closer the distance between the worker vectors corresponding to the jobs of the workers becomes. Then, the similar job group selection unit 31 classifies all the workers to be analyzed into a predetermined number of similar job groups by applying an arbitrary cluster analysis to the worker vectors each calculated for each worker. The cluster analysis may be, for example, a non-hierarchical cluster analysis such as the k-means method and the supervolume method, or a hierarchical cluster analysis such as the Ward method, the nearest neighbor method, a furthest neighbor method, and the centroid method.

Then, the similar job group selection unit 31 selects one similar job group from the multiple similar job groups as a target of segmentation to be described later. In the first example, the similar job group selection unit 31 selects the similar job group to which the viewer (i.e., the user of the display device 4) belongs as the target similar job group of segmentation. In this case, for example, the similar job group selection unit 31 receives information such as the personal ID of the viewer from the display device 4 and determines which of the workers registered in the job related DB 20 corresponds to the viewer, thereby selecting the similar job group to which the viewer belongs. In the second example, the similar job group selection unit 31 selects the target similar job group of segmentation by receiving the input signal S1 which specifies the target similar job group of segmentation from the viewer of the display device 4. In this case, for example, the similar job group selection unit 31 may assist the viewer in selecting the target similar job group by aggregating the job related words corresponding to each worker for each similar job group and displaying the aggregated result of the job related words for each similar job group on the display device 4. In this case, the aggregated results of the job related words for each similar job group may be a list in which the aggregated results of the job related words are intuitively displayed in an easy-to-understand manner by the word cloud, or may be a list of the job related words in which the job related words are arranged in the order of frequent occurrence. According to the second example, the information processing device 1 selects a similar job group in which the viewer is interested as the target similar job group of segmentation.

The segmentation unit 32 divides the target similar job group into a plurality of segments based on one or more attributes included in the basic attribute information D1 of the workers belonging to the target similar job group selected by the similar job group selection unit 31. For example, the segmentation unit 32 divides the target similar job group into multiple segments using two attributes such as age and annual income. It is noted that the segmentation unit 32 may perform segmentation using the attributes of the workers included in the job performance information D2. For example, the segmentation unit 32 may use an evaluation (i.e., the latest personnel evaluation) for the workers belonging to the target similar job group as an attribute to be used for the segmentation. The evaluation described above may be an evaluation of the latest (i.e., at the previous period), or may be an average of performance evaluation in the last few years.

Here, the segmentation unit 32 may fix the number of segments to be generated regardless of the number of the workers belonging to the target similar job group, or may increase the number of segments to be generated with increase in the number of the workers belonging to the target similar job group. In the former case, for example, for each attribute to be used for segmentation, the segmentation unit 32 stores threshold values the number of which corresponds to the number of segments to be generated in advance in the memory 12, and classifies the target similar job group into each segment by referring to the threshold value. For example, when generating nine segments using two attributes, the segmentation unit 32 divides the target similar job group into three using two thresholds for each attribute. In contrast, in the case of increasing the number of segments to be generated with increasing number of workers belonging to the target similar job group, the segmentation unit 32 stores in the memory 12 a table or the like indicating the correspondence between the range of the number of workers belonging to the similar job group and the number of segments to be generated and refers to the above table to determine the number of segments to be generated. In this case, the segmentation unit 32 may determine the number of segments to be generated so as to have the same division number of segments for each attribute, or may determine the number of segments to be generated so as to have a different division number of segments for each attribute. For example, in the former case, when two attributes are used, the segmentation unit 32 sets the number of segments to be generated so as to be a square of two or more integers according to the number of workers belonging to the target similar job group.

The display control unit 33 generates the display signal S2 with reference to the skill related information D3, and transmits the generated display signal S2 to the display device 4 so as to display the segment distribution view or the skill statistics view on the display device 4. The segment distribution view and skill statistics view are described in detail in the section “(6) Display Examples”.

Each component of the text analysis unit 30, the similar job group selection unit 31, the segmentation unit 32, and the display control unit 33 described in FIG. 4 can be realized, for example, by the processor 11 executing the program. More specifically, each component may be implemented by the processor 11 executing a program stored in the memory 12. In addition, the necessary programs may be recorded in any nonvolatile recording medium and installed as necessary to realize each component. Each of these components is not limited to being implemented by software using a program, and may be implemented by any combination of hardware, firmware, and software. Each of these components may also be implemented using user programmable integrated circuitry, such as, for example, FPGA (field-programmable gate array) or a microcomputer In this case, the integrated circuit may be used to realize a program to function as each of the above-described components. Thus, each component may be implemented by hardware other than the processor 11. The above is the same in other example embodiments to be described later.

(5) Processing Flow

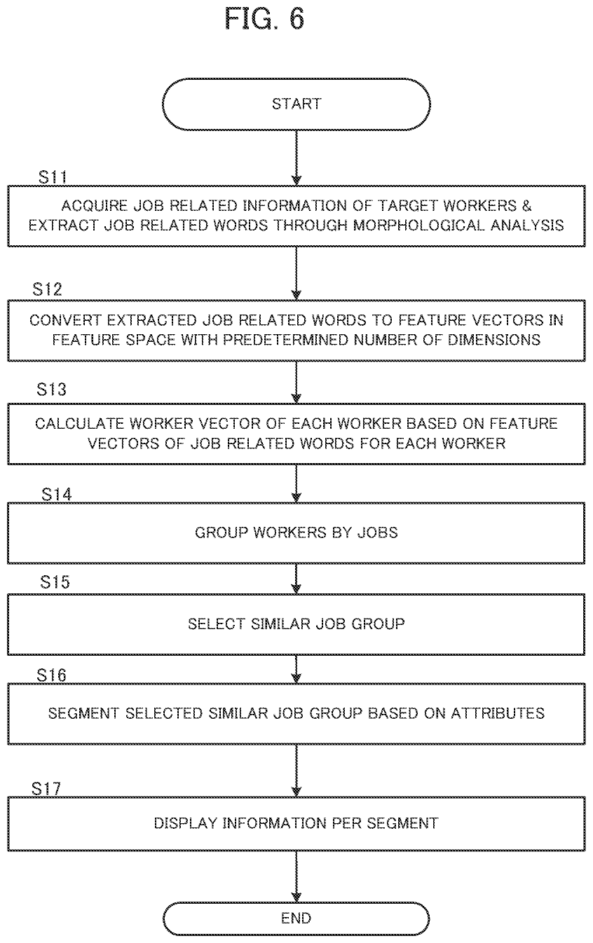

FIG. 6 is an example of a flowchart showing a procedure relating to the display process executed by the processor 11 of the information processing device 1 in the first example embodiment. The processor 11 executes the processing of the flowchart shown in FIG. 6, for example, when receiving a predetermined display request from the display device 4.

First, the text analysis unit 30 of the processor 11 acquires the job performance information D2 of workers from the job related DB 20 and performs morphological analysis or the like on the texts indicated by the job performance information D2 to thereby extract the job related words (step S11).

Next, the similar job group selection unit 31 converts the job related words extracted at step S11 into feature vectors in a feature space with a predetermined number of dimensions (step S12). In this case, for example, the similar job group selection unit 31 performs conversion from the job related words to the feature vectors using a converter configured to output a feature vector with the predetermined number of dimensions when a word is inputted thereto. The similar job group selection unit 31 may store the parameters of the converter in advance in the memory 12 before executing the flowchart, or may be generated by performing machine learning using the job related words extracted at step 11 and the texts from which the job related words are extracted.

Then, the similar job group selection unit 31 calculates a worker vector representing job-related features of each worker in the above-described feature space on the basis of the feature vectors obtained by converting the job related words for each worker (step S13). Furthermore, based on the worker vector of each worker, the similar job group selection unit 31 groups the workers in units of common or similar jobs using any cluster analysis technique such as the k-means method (step S14). Then, the similar job group selection unit 31 selects one similar job group from the multiple similar job groups (step S15). In this case, for example, the similar job group selection unit 31 may select the similar job group to which the user of the display device 4 corresponds, or may select the similar job group specified (designated) by the user of the display device 4.

The segmentation unit 32 performs segmentation of the target similar job group selected at step S15 based on the attributes of the workers belonging to the target similar job group (step S16). In this case, the segmentation unit 32 acquires the basic attribute information D1 of the workers belonging to the target similar job group from the job related DB 20, and classifies the target similar job group into a predetermined number of segments based on at least one attribute indicated by the basic attribute information D1.

Then, the display control unit 33 presents information per segment generated at step S16 (step S17). In this case, the display control unit 33 generates a display signal S2 for displaying the segment distribution view or the skill statistics view, and transmits the display signal S2 to the display device 4 to thereby display the segment distribution view or the skill statistics view on the display device 4.

(6) Display Examples

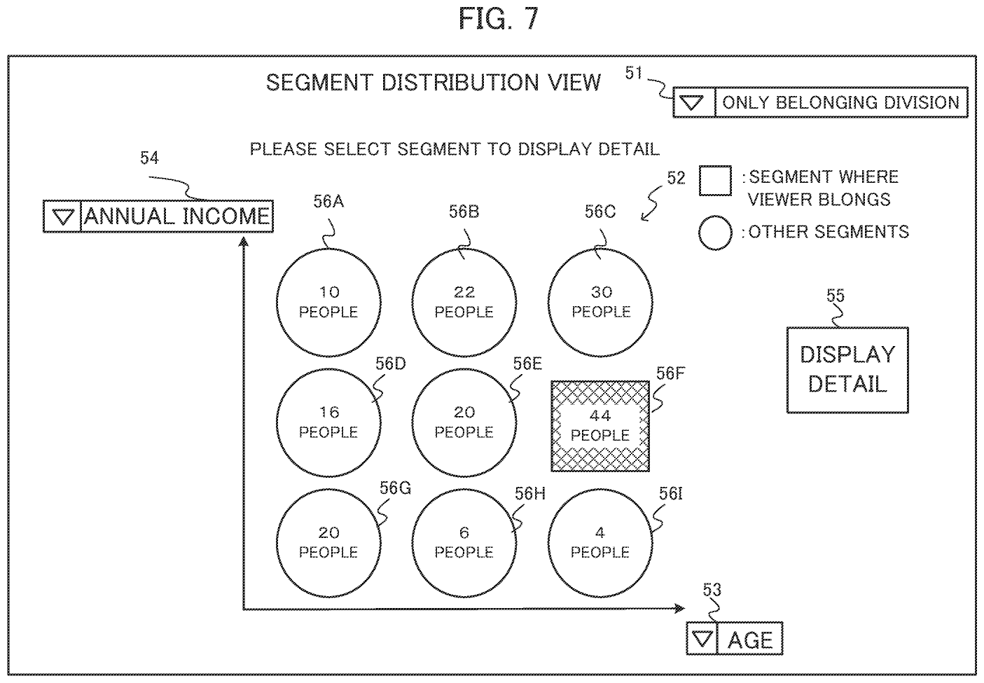

Next, examples of the segment distribution view and the skill statistics view displayed by the display device 4 based on the display signal S2 generated by the display control unit 33 of the information processing device 1 will be described with reference to FIGS. 7 to 12.

(6-1) Segment Distribution View

FIG. 7 is a display example of a segment distribution view for displaying the worker number distribution for each segment. By transmitting the display signal S2 to the display device 4, the display control unit 33 displays on the display device 4 the segment distribution view mainly including a target worker selection field 51, a worker number distribution graph 52, a first attribute selection field 53, a second attribute selection field 54, and a detailed display selection field 55.

The target worker selection field 51 is an input field for selecting the affiliation of the workers to be analyzed. Here, as an example, the target worker selection field 51 is a selection field in the pull-down menu form, and each affiliation of the workers registered in the job related DB 20 can be selected therefrom. In the example of FIG. 7, an option is selected in the target worker selection field 51 to select workers belonging to the business division to which the viewer belongs as target workers of analysis. If the job related DB 20 includes information on workers engaged in the duties of other companies other than the company to which the viewer belongs, the display control unit 33 may present an option for selecting workers engaged in the duties of the other companies as target workers of analysis in the target worker selection field 51.

When the affiliation of the target workers of analysis is specified by the target worker selection field 51, the text analysis unit 30 extracts the job performance information D2 of the workers belonging to the specified affiliation from the job related DB 20, and extracts the job related words described above and converts them to the feature vectors. Thereafter, the selection of the target similar job group (e.g., a plurality of workers with a job common or similar to the job of the viewer) by the similar job group selection unit 31 and the segmentation by the segmentation unit 32 are executed, and the display control unit 33 updates the display of the worker number distribution graph 52 based on the execution results of these processes. It is noted that the information processing device 1 may use the selection result in the target worker selection field 51 in the display processing by the display control unit 33 after execution of segmentation or the like. In this case, the text analysis unit 30 extracts all available job performance information D2 of workers from the job related DB 20 regardless of the selection result in the target worker selection field 51, and extracts the job related words described above and converts them to the feature vectors. Then, after the selection of the target similar job group by the similar job group selection unit 31 and the segmentation by the segmentation unit 32, the display control unit 33 performs the calculation of the above-described worker number distribution for the workers belonging to the affiliation selected in the target worker selection field 51 and updates the display of the worker number distribution graph 52. In this example embodiment, it is possible to suitably prevent the shortage of the necessary number of data to be used by the text analysis unit 30 and the like.

The first attribute selection field 53 is a selection field for selecting the first attribute which is one of the two attributes to be used for segmentation by the segmentation unit 32 (i.e., used as the coordinate axis of the worker number distribution graph 52 to be described later). Similarly, the second attribute selection field 54 is a selection field for selecting the second attribute that is the other of the two attributes to be used for segmentation by the segmentation unit 32. In FIG. 7, each of the first attribute selection field 53 and the second attribute selection field 54 is a selection field in a pull-down menu format, and in each selection field, an arbitrary attribute can be selected from attributes (e.g., annual income, age, position, post) registered in the basic attribute information D1. The same attribute cannot be selected in the first attribute selection field 53 and the second attribute selection field 54 at the same time. In this way, the display control unit 33 enables selections of the first attribute and the second attribute to be used for segmentation by the segmentation unit 32, thereby suitably forming the segments based on the attributes in which the viewer is interested.

The worker number distribution graph 52 is a graph that clearly indicates the number of the workers belonging to each segment and the position of each segment on the two-dimensional coordinates whose axes are the first attribute specified by the first attribute selection field 53 and the second attribute specified by the second attribute selection field 54. Here, the segmentation unit 32 performs segmentation of the similar job group to which the viewer belongs based on the age and annual income. In this case, the segmentation unit 32 divides the target similar job group into three using two thresholds with respect to age, and further divides the target similar job group into three using two thresholds with respect to the annual income, thereby dividing the target similar job group into nine segments “A” to “I”. Then, the display control unit 33 displays the segment FIGS. 56A to 561 representing each segment on the worker number distribution graph 52 while displaying the number of workers belonging to each segment on each segment FIGS. 56A to 561.

As described above, according to the segment distribution view shown in FIG. 7, the display control unit 33 can suitably present the distribution of the workers belonging to the target similar job group to the viewer on the two-dimensional coordinates based on the two attributes selected by the viewer. In addition, the display control unit 33 displays, by a rectangle, the segment FIG. 56F representing the segment (in this case, the segment F) to which the viewer belongs while displaying, by circles, the other segment FIGS. 56A to 56E, 56G to 561 so that the viewer can identify the segment to which the viewer belongs. Thus, the display control unit 33 allows the viewer to appropriately recognize the segment where the viewer belongs at the present time.

In addition, the segment FIGS. 56A to 561 can be selected respectively, and if the display control unit 33 detects the selection of any of the segment figures, the display control unit 33 highlights the selected segment figure (here, the segment FIG. 56F). Then, the display control unit 33 transmits the display signal S2 of the skill statistics view targeting the segment corresponding to the selected segment figure to the display device 4 if the selection of the detailed display selection field 55 is detected in a condition in which any of the segment figures are selected. It is noted that the segment FIGS. 56A to 561 can be selected in combination. Thus, if the viewer wishes to view comprehensive skill information for groups corresponding to higher levels of the attribute (e.g., annual income), the viewer can select segment figures (segment FIGS. 56A to 56C in case of annual income) of the multiple segments corresponding to the higher levels of the attribute. These display examples will be described later.

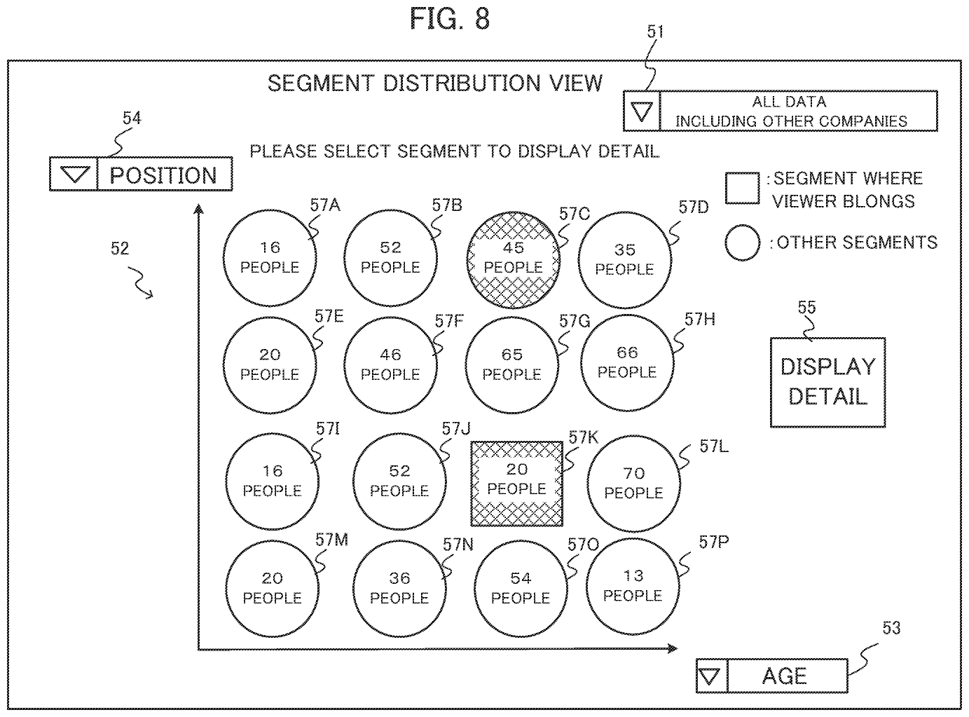

FIG. 8 is a display example of the segment distribution view after “all data including other companies” is selected in the target worker selection field 51 and “position” is selected in the second attribute selection field 54.

In FIG. 8, the display control unit 33 displays the segment FIGS. 57A to 57P corresponding to the sixteen segments A to P on the worker number distribution graph 52. In this case, first, the text analysis unit 30 extracts the job performance information D2 of all the workers from the job related DB 20 and performs text analysis, and the similar job group selection unit 31 selects the target similar job group of segmentation. Next, since the item “age” is selected in the first attribute selection field 53 and the item “position” is selected in the second attribute selection field 54, the segmentation unit 32 classifies the target similar job group into segments based on the age and position. Further, the segmentation unit 32 changes the number of segments (from 9 to 16 in this case) according to the increase in the worker number of the target similar job group due to the changes in the selection of the target worker selection field 51. As described above, the segmentation unit 32 changes the number of segments according to the number of the workers which belong to the target similar job group. Thereby, the segmentation unit 32 keeps the number of workers belonging to each segment at an appropriate number for displaying information relating to the skill to be described later.

Further, in FIG. 8, the display control unit 33 displays the segment FIG. 57K corresponding to the segment (in this case, the segment K) to which the viewer belongs in a shape different from the other segment figures. Furthermore, since the segment FIG. 57C and the segment FIG. 57K have been selected, the display control unit 33 highlights them.

(6-2) Skill Statistics View

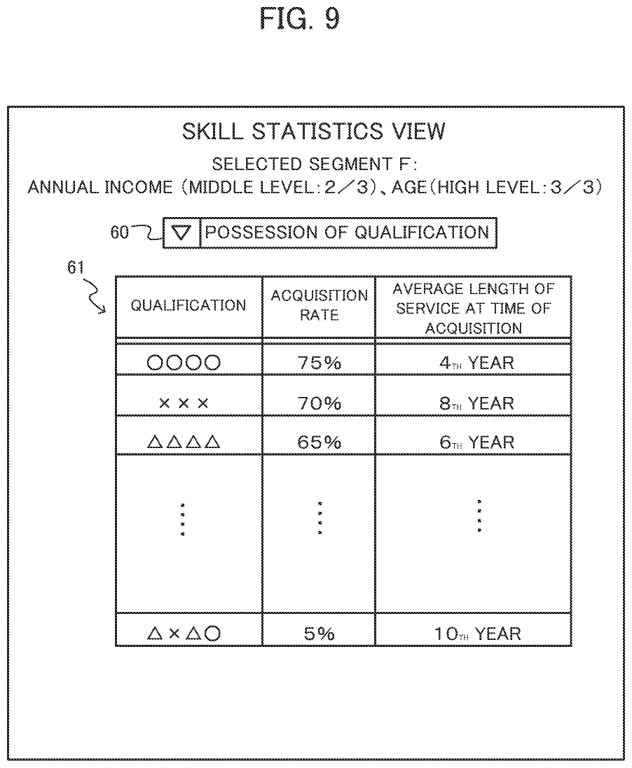

FIG. 9 is a display example of the skill statistics view with respect to the statistical display of skills. Here, the display control unit 33 detects that the detailed display selection field 55 is selected in a condition where the segment F is selected in FIG. 7, and then displays the skill statistics view shown in FIG. 9 on the display device 4 by transmitting the display signal S2 to the display device 4. The display control unit 33 mainly displays a display type selection field 60 and a skill statistics display field 61 on the skill statistics view. Hereafter, the segment specified (designated) on the segment distribution view are also referred to as “specified segment”.

The display type selection field 60 is a field for selecting the type of information to be displayed in the skill statistics display field 61. In FIG. 9, “possession of qualification” is selected in the display type selection field 60. The display type selection field 60 may display options in a selectable manner including not only “possession of qualification” but also other type of skill-related information such as “received training” and “presentation in academic conference”. Further, as will be described later, the display type selection field 60 displays “job related word” as an option, and allows the statistical information of the job related words related to the workers belonging to the specified segment F to be displayed.

The skill statistics display field 61 displays statistical information on the display type selected in the display type selection field 60. In FIG. 9, as an example, the display control unit 3 displays, on the skill statistics display field 61, a table including each item of “qualification”, “acquisition rate”, and “average length of service at time of acquisition”. The item “qualification” refers to qualifications which the workers belonging to the specified segment (Segment F) possess. The item “acquisition rate” indicates the rate of the workers who possess each of the qualifications among the workers belonging to the specified segment. The item “average length of service at time of acquisition” indicates the average length of service at the time when the workers belonging to the specified segment acquires each of the qualifications (i.e., the average number of years of service at the time of acquisition of the qualification).

In this case, the display control unit 33 acquires the skill related information D3 of the workers belonging to the specified segment (segment F) from the job related DB 20 and recognizes the qualifications possessed by the workers and their lengths of services at the company at the time of acquiring the respective qualifications. The display control unit 33 generates a list of qualifications possessed by the workers, and calculates the acquisition rate of each qualification and the average length of service at the time of acquisition for each qualification. In the case of a scored qualification, the display control unit 33 sets one or more thresholds for the score, and calculates the acquisition rate by determining that a worker having the score equal to or larger than the threshold is a holder of the qualification. For example, in the case of the qualification “A” on a scale on which 100 is perfection, the display control unit 33 sets the first threshold to 60 and the second threshold to 80. Then, the display control unit 33 calculates the rate of those having the score equal to or larger than the first threshold for the qualification A and the rate of those having the score equal to or larger than the second threshold for the qualification A. Then, the display control unit 33 provide, on the skill statistics display field 61, each row “qualification A (60 or more)” and “qualification A (80 or more)” and displays the calculated respective ratios as the acquisition rates.

As described above, the display control unit 33 statistically displays information on skills such as the qualifications of the workers belonging to the specified segment. Thereby, the viewer can suitably grasp the skills possessed by the workers belonging to the segment in which the viewer is interested. In addition, when viewing the skill statistics view for the segment to which the viewer belongs, the viewer can suitably grasp the qualifications that workers having the same attribute as the viewer in the similar job group tends to possess, or the qualification that has a scarce value that most of the workers do not possess. In FIG. 9, instead of displaying the qualifications in order of decreasing acquisition rate on the skill statistics display field 61, for example, the display control unit 33 may rearrange and display the qualifications in order of increasing acquisition rate when the item “acquisition rate” is selected.

Further, when the display control unit 33 detects that any qualification has been selected from the list of qualifications displayed in the skill statistics display field 61, it may cause the display device 4 to display a website related to the selected qualification such as a course necessary for acquiring the selected qualification. In this case, for example, the display control unit 33 refers to a table or the like in which the URL or the like of the qualification-related site is associated for each qualification, and transmits the corresponding URL or the like to the display device 4 thereby to display the qualification-related site on the display device 4. The above table or the like is stored in advance, for example, in the memory 12 or the storage device 2. Similarly, in a case where a list of training is displayed in the skill statistics display field 61, the display control unit 33 may display a training-related site for guiding the selected training on the display device 4 when detecting that an arbitrary training has been selected from the list.

Instead of displaying the statistical information relating to the possession of the qualification or the like in the form of a list, the display control unit 33 may visually display the statistical information of the possession of the qualification, for example, in the form of a word cloud. In this case, for example, the display control unit 33 may switch, according to the user input, a mode in which the word of the qualification with higher acquisition rate is displayed to be more conspicuous and a mode in which the word of the qualification with lower acquisition rate is displayed to be more conspicuous. The display control unit 33 may switch, according to the user input, between the above-described list display and the other display such as the word cloud display. Similarly, when items other than the possession of qualification is selected in the display type selection field 60, statistical information relating to skill may be displayed by various display modes.

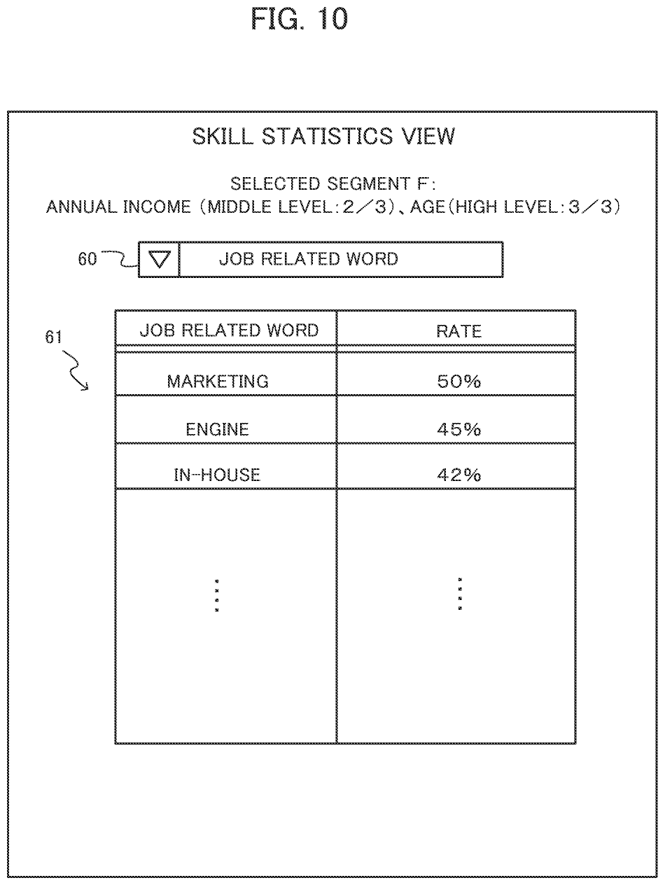

FIG. 10 is a display example of a skill statistics view in which the “job related word” is selected in the display type selection field 60 of the skill statistics view shown in FIG. 9. In this case, on the skill statistics display field 61, a table having the item “job related word” and the item “rate” is displayed. The item “job related word” indicates the job related words corresponding to each of the workers belonging to the specified segment. The item “rate” indicates the rate of workers whose job related word of interest is extracted by the text analysis unit 30 among the workers belonging to the specified segment.

In this case, the display control unit 33 detects that the “job related word” is selected in the display type selection field 60, and extracts the job related word corresponding to each of the workers belonging to the specified segment from the job related words extracted by the text analysis unit 30. Then, the display control unit 33 aggregates the job related words corresponding to each of the workers belonging to the specified segment and generates the display information of the skill statistics display field 61 shown in FIG. 10.

According to the display example shown in FIG. 10, the viewer can appropriately grasp the statistical information of the job related words corresponding to the workers belonging to the segment of interest.

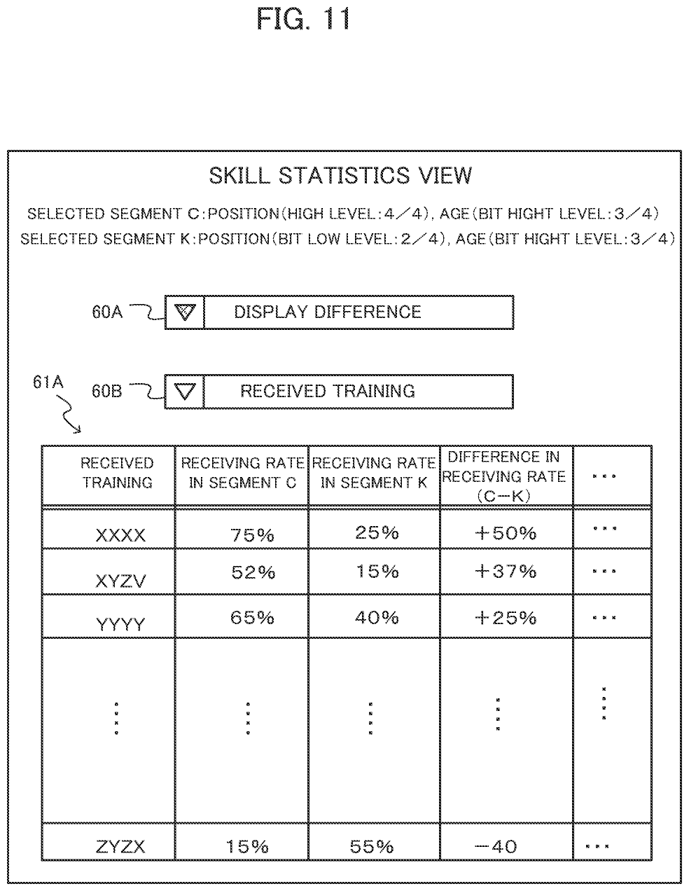

FIG. 11 is a display example of a skill statistics view when two segments are selected. In the example of FIG. 11, the display control unit 33 detects that the detailed display selection field 55 is selected in the state that the segment C indicated by the segment FIG. 57C and the segment K indicated by the segment FIG. 57K are selected in the segment distribution view shown in FIG. 8. Then, the display control unit 33 displays a first display type selection field 60A, a second display type selection field 60B, and a skill statistics display field 61A on the skill statistics view.

The first display type selection field 60A is a selection field that is displayed when two segments are selected. Specifically, the first display type selection field 60A accepts a choice from two options: displaying the difference in the skills of the workers between the two segments of interest; or comprehensively displaying statistical information on the skills of the workers belonging to the two segments of interest. If three or more segments in the segment distribution view are selected, the display control unit 33 considers it impossible to perform the former option that is displaying the difference relating to the skill and it does not display the option in the first display type selection field 60A. In this case, the display control unit 33 displays a skill statistics view that comprehensively displays statistical information regarding the skills of the workers belonging to three or more specified segments.

The second display type selection field 60B is a selection field in which the type of information related to the skill can be selected as in the display type selection field 60 (see FIG. 9) that is displayed when one segment was selected.

The skill statistical display field 61A is a field for displaying statistical information on skills corresponding to the display types selected respectively in the first display type selection field 60A and the second display type selection field 60B. Here, since the option “display difference” is selected in the first display type selection field 60A and the option “received training” is selected in the second display type selection field 60B, the display control unit 33 displays, on the skill statistics display field 61A, a table indicative of the difference with respect to the status on whether or not the workers belonging to the specified segments has received the training. Specifically, the display control unit 33 refers to the skill related information D3 corresponding to the workers belonging to the specified segments, and displays, on the skill statistics display field 61, a table including each item of “received training”, “receiving rate in segment C”, “receiving rate in segment K”, and “difference in receiving rate (C-K)”.

Here, the item “received training” indicates the training taken by the workers belonging to the specified segments. The item “receiving rate in segment C” indicates the rate of the workers which have received the training of interest among the worker belonging to segment C. The item “receiving rate in segment K” indicates the rate of the workers which have received the training of interest among the worker belonging to segment K. The item “receiving rate in segment K”, and “difference in receiving rate (C-K)” indicates the difference between the rate indicated by the corresponding item “receiving rate in segment C” and the rate indicated by the corresponding item “receiving rate in segment K”.

In this way, the display control unit 33 displays, on the skill statistics view, statistical information (in this case, the difference in the rate of receiving training) indicative of the difference in the skill between the two specified segments when the option “display difference” is selected in the skill statistics display field 61A. This allows the viewer to better grasp the difference between the segments with respect to the type of the specified skill.

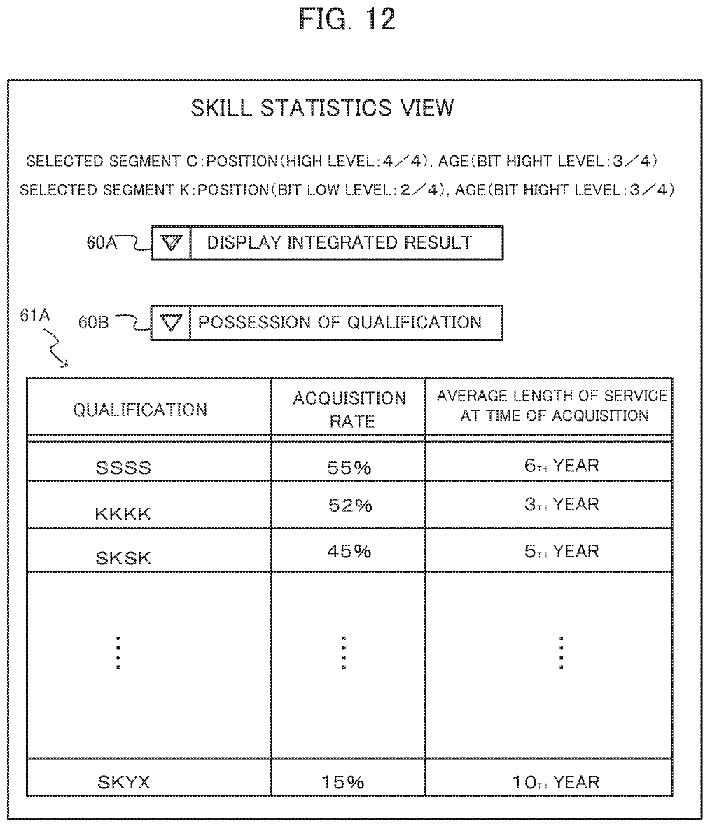

FIG. 12 is a display example of the skill statistics view that comprehensively displays statistical information regarding the skill when multiple segments are selected. In this case, the display control unit 33 detects that the option “integrated result” is specified in the first display type selection field 60A in the skill statistics view shown in FIG. 11, and displays statistical information targeting the entire workers belonging to the specified segments (segment C and segment K). In the example shown in FIG. 12, since “possession of qualification” is selected in the second display type selection field 60B, the display control unit 33 displays, on the skill statistics display field 61A, a list showing the name of qualifications possessed by any of the entire workers belonging to the specified segments, the acquisition rate of each qualification, and the average length of service at the time of the acquisition. Even when the specified segments are three or more, the display control unit 33 displays statistical information targeting the entire workers belonging to the specified segments. The display control unit 33 may indicate the average age at the time of acquisition of the qualification on the skill statistics display field 61A in place of, or in addition to indicating the acquisition rate of the qualification and the average length of service at the time of the acquisition. Similarly, when displaying the skill statistics view relating to the received training, the display control unit 33 may display the statistical information indicating the average age at the time of receiving the training of interest on the skill statistics display field 61A.

In this way, according to the display example shown in FIG. 12, when multiple segments are selected, the display control unit 33 can comprehensively display statistical information regarding the skill of the workers belonging to the selected segments.

Here, the effect according to the display shown in FIGS. 7 to 12 will be supplementally described. According to the above-described display examples, when the viewer is an employee, it is possible to suitably browse the types of attributes, such as the age and annual income, of the workers in the similar job group to which the viewer belongs and the types of skills of the workers in the similar job group to which the viewer belongs. This enables the viewer to appropriately grasp the skill retention status of younger generations than the viewer's generation, as well as the skill-possession status in such segments with higher annual incomes in the same generation as the viewer, and to suitably promote the autonomous carrier formation by the viewer. In addition, even when a superior having subordinates is a viewer, it is possible to grasp the skills of the segment group to which the subordinates belongs and utilize the information for the training and guidance for the subordinates. In addition, even when an executive of a company becomes a viewer, it can suitably grasp the skills already possessed by each similar job group and the prospective skills to be possessed. Therefore, in this case, it is possible to utilize the system in deciding the education policy and the like from the management viewpoint.

### Second Example Embodiment

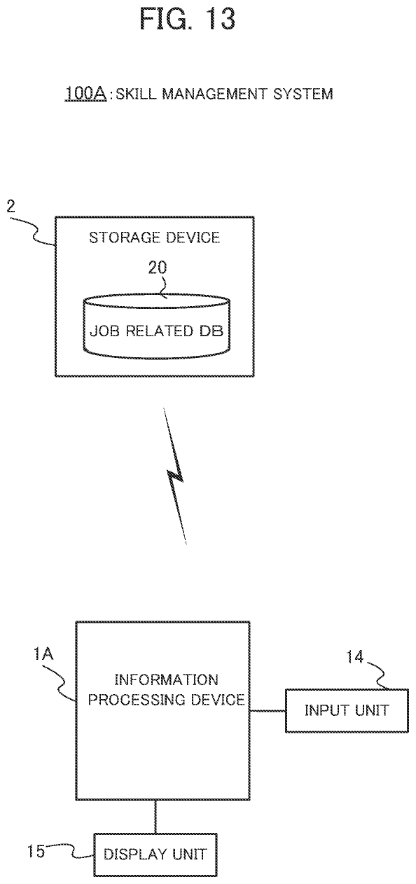

FIG. 13 shows a schematic configuration of a skill management system 100A according to a second example embodiment. The skill management system 100A includes an information processing device 1A and a storage device 2. The information processing device 1A in the second example embodiment differs from the information processing device 1 in the first example embodiment in that it comprises both functions of the information processing device 1 and the display device 4 in the first example embodiment. Hereinafter, the same configuration as that of the first example embodiment is appropriately denoted by the same reference numerals, and description thereof will be omitted.

The information processing device 1A is a terminal operated by a viewer, and is connected to an input unit 14 and a display unit 15. The information processing device 1A may be a terminal (e.g., a tablet-type terminal) that incorporates an input unit 14 and a display unit 15. Then, by performing the same processing as the information processing device 1 in the first example embodiment does, the information processing device 1A generates the display signal relating to the segment distribution view or the skill statistics view and inputs the display signal to the display unit 15, thereby displaying the segment distribution view or the skill statistics view on the display unit 15. Similarly, the information processing device 1A receives the input signal from the input unit 14, and receives the designation or the like of the segments by the user.

Even in the second example embodiment, the skill management system 100A can suitably present the segment distribution view or the skill statistics view to the user of the information processing device 1A. The display unit 15 is an example of a display device.

### Third Example Embodiment

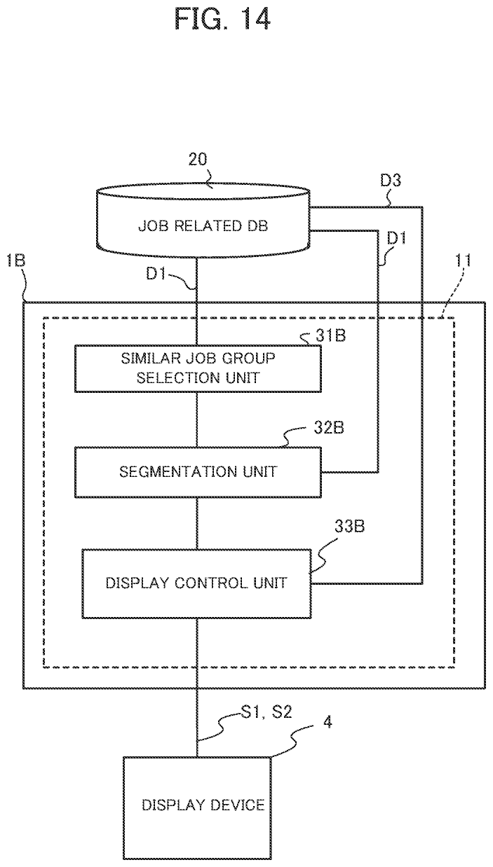

FIG. 14 shows a functional block diagram of an information processing device 1B according to a third example embodiment. In the third example embodiment, the information processing device 1B differs from the first example embodiment in that it performs a grouping process of the workers based on job type information. The system configuration in the third example embodiment is the same as the configuration shown in FIG. 1, and the hardware configuration of each device is the same as the configuration shown in FIGS. 3A and 3B. Thus, the description thereof will be omitted. Further, the same configuration as that of the first example embodiment is appropriately denoted by the same reference numerals, and description thereof will be omitted.

As shown in FIG. 14, the processor 11 of the information processing device 1B according to the third example embodiment functionally includes a similar job group selection unit 31B, a segmentation unit 32B, and a display control unit 33B.

The similar job group selection unit 31B acquires the basic attribute information D1 corresponding to workers of interest from the job related DB 20, and carries out the grouping of the workers based on the information (job type information) on the job type included in the acquired basic attribute information D1. In this case, in the first example, if the job types indicated by the referred job type information corresponding to multiple workers are identical, the similar job group selection unit 31B determines that the multiple workers corresponding to the above-mentioned job type information belong to the same similar job group. In the second example, if the job types indicated by the referred job type information corresponding to multiple workers are identical or similar, the similar job group selection unit 31B determines that the multiple workers corresponding to the above-mentioned job type information belong to the same similar job group. In this case, for example, the similar job group selection unit 31B stores table information in which similar job types are associated with one another in advance in the memory 12 or the like, and refers to the table information to determine the similarity of the job types.

Thereafter, the similar job group selection unit 31B selects one similar job group from the grouped similar job groups as the target of segmentation. Since this selection method is the same as the method described in the first example embodiment, a description thereof will be omitted.

The segmentation unit 32B refers to the basic attribute information D1 and divides the target similar job group into multiple segments based on one or more attributes included in the basic attribute information D1 of the workers belonging to target similar job group selected by the similar job group selection unit 31B. The method of this segmentation is the same as that of the first example embodiment. Further, the display control unit 33B generates the display signal S2 by referring to the skill related information D3 and transmits the generated display signal S2 to the display device 4 thereby to display the segment distribution view or the skill statistics view on the display device 4. In this case, similarly to the first example embodiment, the display control unit 33B displays the segment distribution view and the skill statistics view shown in FIGS. 7 to 12 on the display device 4.

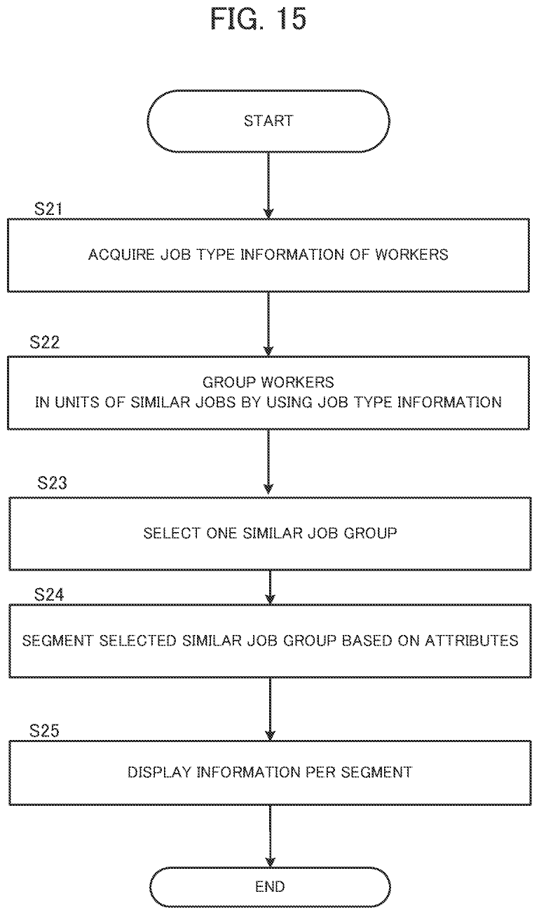

FIG. 15 is an example of a flowchart illustrating a procedure relating to a display process performed by the processor 11 of the information processing device 1B in the third example embodiment.

First, the similar job group selection unit 31B of the processor 11 acquires the job type information included in the basic attribute information D1 of workers of interest from the job related DB 20 (step S21). Then, the similar job group selection unit 31B groups the workers in units of similar jobs based on the job type information acquired at step S21 (step S22). Then, the similar job group selection unit 31B selects one similar job group from the generated similar job groups (step S23). In this case, in the same way as in the first example embodiment, the common job group selection unit 31B may select the similar job group to which the user of the display device 4 belongs, or may select the similar job group designated by the user of the display device 4.

Then, the segmentation unit 32B performs segmentation based on the attributes of the workers belonging to the similar job group selected at step S23 (step S24). In this case, the segmentation unit 32 acquires the basic attribute information D1 of the workers belonging to the target similar job group from the job related DB 20, and classifies the target similar job group into a predetermined number of segments based on at least one attribute indicated by the basic attribute information D1.

Then, the display control unit 33B performs presentation of information per segment generated at step S24 (step S25). In this case, the display control unit 33B generates a display signal S2 for displaying the segment distribution view or the skill statistics view, and transmits the display signal S2 to the display device 4, thereby displaying the segment distribution view or the skill statistics view on the display device 4.

In this way, even by referring to the job type information of the target workers, the information processing device 1B can suitably perform grouping of the workers in units of common or similar jobs and select the similar job group to perform segmentation.

The third example embodiment may be combined with the second example embodiment. Namely, the information processing device 1B may have, or may be connected through an interface to, a display unit and accept various inputs by the input unit and display the segment distribution view and the skill statistics view on the display unit.

### Fourth Example Embodiment

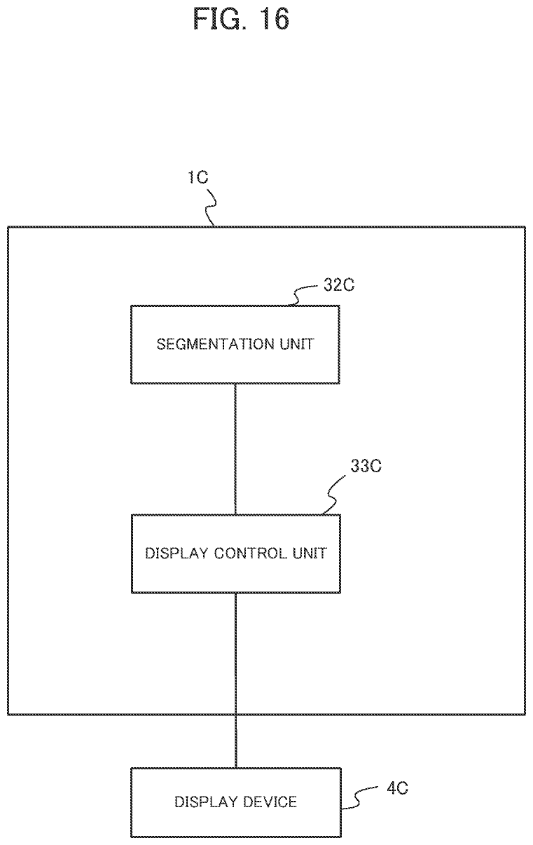

FIG. 16 is a schematic configuration diagram of an information processing device 1C according to a fourth example embodiment. As shown in FIG. 16, the information processing device 1C mainly includes a segmentation unit 32C and a display control unit 33C.

The segmentation unit 32C is configured to divide a similar job group, to which multiple workers engaged in a common or similar job belong, into multiple segments based on one or more attributes of the workers. In this case, for example, the segmentation unit 32C may be realized by the text analysis unit 30 and the similar job group selection unit 31 in the first example embodiment or may be realized by the similar job group selection unit 31B in the third example embodiment. In another example, an external device (not shown) selects multiple workers engaged in a common or similar job and then the segmentation unit 32C divide the similar job group configured by the above-described workers selected by the external device into the multiple segments based on one or more attributes of the workers.

The display control unit 33C is configured to display segment information, which is information regarding workers per segment, on the display device 4C. For example, the display control unit 33C is realized by the display control unit 33B in the first example embodiment or the display control unit 33 in the third example embodiment. Here, the segment information may be information indicative of the number of workers for each segment displayed on the segment distribution view, or may be statistical information regarding the skills of the workers corresponding to one or more segments displayed on the skill statistics view.

According to the configuration of the fourth example embodiment, the information processing device 1C can suitably display information regarding workers per segment when workers belonging to the similar job group is divided into multiple segments according to one or more attributes.

In the example embodiments described above, the program is stored by any type of a non-transitory computer-readable medium (non-transitory computer readable medium) and can be supplied to a control unit or the like that is a computer. The non-transitory computer-readable medium include any type of a tangible storage medium. Examples of the non-transitory computer readable medium include a magnetic storage medium (e.g., a flexible disk, a magnetic tape, a hard disk drive), a magnetic-optical storage medium (e.g., a magnetic optical disk), CD-ROM (Read Only Memory), CD-R, CD-R/W, a solid-state memory (e.g., a mask ROM, a PROM (Programmable ROM), an EPROM (Erasable PROM), a flash ROM, a RAM (Random Access Memory)). The program may also be provided to the computer by any type of a transitory computer readable medium. Examples of the transitory computer readable medium include an electrical signal, an optical signal, and an electromagnetic wave. The transitory computer readable medium can provide the program to the computer through a wired channel such as wires and optical fibers or a wireless channel.

The whole or a part of the example embodiments described above can be described as, but not limited to, the following Supplementary Notes.

[Supplementary Note 1]

An information processing device comprising:

a segmentation unit configured to divide a similar job group, to which multiple workers engaged in a common or similar job belong, into multiple segments based on one or more attributes of the workers; and

a display control unit configured to display segment information, which is information regarding workers per segment, on a display device.

[Supplementary Note 2]

The information processing device according to Supplementary Note 1,

wherein the display control unit displays, as the segment information, the number of workers for each of the multiple segments on the display device.

[Supplementary Note 3]

The information processing device according to Supplementary Note 1, wherein the display control unit displays, as the segment information, statistical information on skills of workers corresponding to one or more specified segments which are specified from the multiple segments on the display device.

[Supplementary Note 4]

The information processing device according to Supplementary Note 3,

wherein, when a plurality of segments are designated as the one or more specified segments, the display control unit displays, as the segment information, the statistical information on the skills of the workers corresponding to the plurality of segments on the display device.

[Supplementary Note 5]

The information processing device according to Supplementary Note 3,

wherein, when two segments are specified as the one or more specified segments, the display control unit displays, as the segment information, the statistical information indicating a difference in the skills of the workers corresponding to each of the specified segments on the display device.

[Supplementary Note 6]

The information processing device according to any one of Supplementary Notes 3 to 5,

wherein the display control unit displays, as the statistical information on the skills, statistical information relating to a qualification possessed by the workers corresponding to the one or more specified segment or statistical information relating to a training received by the workers corresponding to the one or more specified segment on the display device.

[Supplementary Note 7]

The information processing device according to Supplementary Note 6,

wherein the display control unit displays on the display device, as the statistical information on the skills, at least one of

a rate of acquiring the qualification or a rate of receiving the training,

an average length of service at a time of acquiring the qualification or receiving the training, or

an age at the time of acquiring the qualification or receiving the training.

[Supplementary Note 8]

The information processing device according to any one of Supplementary Notes 1 to 7,

wherein the one or more attributes of the workers is at least one attribute selected from an age, an annual income, a position, or an evaluation regarding the workers.

[Supplementary Note 9]

The information processing device according to any one of Supplementary Notes 1 to 8, further comprising

a similar job group selection unit configured to
divide the workers into multiple similar job groups in units of common or similar jobs, based on job performance information indicative of job performances of the workers, and
select one similar job group of the multiple similar job groups as the similar job group subjected to the division into the multiple segments.

[Supplementary Note 10]

The information processing device according to Supplementary Note 9, further comprising

a text analysis unit configured to extract words from texts included in the job performance information and converting the words into feature vectors in a feature space with a predetermined number of dimensions,

wherein the similar job group selection unit divides the workers into the multiple similar job groups based on the feature vectors of the words corresponding to each of the workers.

[Supplementary Note 11]

The information processing device according to any one of Supplementary Notes 1 to 10,

wherein the segmentation unit determines the number of the multiple segments based on the number of the workers belonging to the target similar job group.

[Supplementary Note 12]

The information processing device according to any one of Supplementary Notes 1 to 11,

wherein the display control unit receives an input specifying a target of extraction of the similar job groups.

[Supplementary Note 13]

A control method executed by an information processing device, the control method comprising:

dividing a similar job group, to which multiple workers engaged in a common or similar job belong, into multiple segments based on one or more attributes of the workers; and

displaying segment information, which is information regarding workers per segment, on a display device.

[Supplementary Note 14]

A storage medium storing a program executed by a computer, the program causing the computer to function as:

a segmentation unit configured to divide a similar job group, to which multiple workers engaged in a common or similar job belong, into multiple segments based on one or more attributes of the workers; and

a display control unit configured to display segment information, which is information regarding workers per segment, on a display device.

While the invention has been particularly shown and described with reference to example embodiments thereof, the invention is not limited to these example embodiments. It will be understood by those of ordinary skilled in the art that various changes in form and details may be made therein without departing from the spirit and scope of the present invention as defined by the claims. In other words, it is needless to say that the present invention includes various modifications that could be made by a person skilled in the art according to the entire disclosure including the scope of the claims, and the technical philosophy. All patent and Non-Patent Literatures mentioned in this specification are incorporated by reference in its entirety.

### DESCRIPTION OF REFERENCE NUMERALS

1, 1A to 1C Information processing device
2 Storage device
4, 4C Display device
100, 100A Skill management system

What is claimed is:

1. An information processing device comprising:
at least one memory configured to store instructions; and
at least one processor configured to execute the instructions to
divide a similar job group, to which multiple workers engaged in a common or similar job belong, into multiple segments based on one or more attributes of the workers; and
display segment information, which is information regarding workers per segment, on a display device.

2. The information processing device according to claim 1,
wherein the at least one processor is configured to execute the instructions to display, as the segment information, the number of workers for each of the multiple segments on the display device.

3. The information processing device according to claim 1,
wherein the at least one processor is configured to execute the instructions to display, as the segment information, statistical information on skills of workers corresponding to one or more specified segments which are specified from the multiple segments on the display device.

4. The information processing device according to claim 3,
wherein, when a plurality of segments are designated as the one or more specified segments, the at least one processor is configured to execute the instructions to display, as the segment information, the statistical information on the skills of the workers corresponding to the plurality of segments on the display device.

5. The information processing device according to claim 3,
wherein, when two segments are specified as the one or more specified segments, the at least one processor is configured to execute the instructions to display, as the segment information, the statistical information indicating a difference in the skills of the workers corresponding to each of the specified segments on the display device.

6. The information processing device according to claim 3,
wherein the at least one processor is configured to execute the instructions to display, as the statistical information on the skills, statistical information relating to a qualification possessed by the workers corresponding to the one or more specified segment or statistical information relating to a training received by the workers corresponding to the one or more specified segment on the display device.

7. The information processing device according to claim 6,
wherein the at least one processor is configured to execute the instructions to display on the display device, as the statistical information on the skills, at least one of
a rate of acquiring the qualification or a rate of receiving the training by the workers corresponding to the one or more specified segments,
an average length of service at a time of acquiring the qualification or receiving the training, or
an age at the time of acquiring the qualification or receiving the training.

8. The information processing device according to claim 1,
wherein the one or more attributes of the workers is at least one attribute selected from an age, an annual income, a position, or an evaluation regarding the workers.

9. The information processing device according to claim 1, wherein
the at least one processor is configured to further execute the instructions to
divide workers into multiple similar job groups in units of common or similar jobs, based on job performance information indicative of job performances of the workers, and
select one similar job group of the multiple similar job groups as the similar job group subjected to the division into the multiple segments.

10. The information processing device according to claim 9,
wherein the at least one processor is configured to further execute the instructions to extract words from texts included in the job performance information and converting the words into feature vectors in a feature space with a predetermined number of dimensions, and
wherein the at least one processor is configured to execute the instructions to divide the workers into the multiple similar job groups based on the feature vectors of the words corresponding to each of the workers.

11. The information processing device according to claim 1,
wherein at least one processor is configured to execute the instructions to determine the number of the multiple segments based on the number of the workers belonging to the similar job group.

12. The information processing device according to claim 1,
wherein the at least one processor is configured to execute the instructions to receive an input specifying a target of extraction of the similar job group.

13. A control method executed by an information processing device, the control method comprising:
dividing a similar job group, to which multiple workers engaged in a common or similar job belong, into multiple segments based on one or more attributes of the workers; and
displaying segment information, which is information regarding workers per segment, on a display device.

14. A non-transitory computer readable storage medium storing a program executed by a computer, the program causing the computer to:
divide a similar job group, to which multiple workers engaged in a common or similar job belong, into multiple segments based on one or more attributes of the workers; and
display segment information, which is information regarding workers per segment, on a display device.
